(19) United States
(12) Patent Application Publication
(10) Pub. No.: US 2006/0029849 A1
(43) Pub. Date: Feb. 9, 2006

(54) System for water reclamation from an exhaust gas flow of a fuel cell of an aircraft

(76) Inventor: Dirk Metzler, Hoerbranz (AT)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/184,221

(22) Filed: Jul. 18, 2005

(30) Foreign Application Priority Data
Jul. 19, 2004 (DE) 10 2004 034 870.7

(51) Int. Cl. H01M 8/04; B64D 33/00

(52) U.S. Cl. 429/26; 244/53 R

(57) ABSTRACT

The present invention relates to a system for water reclamation from an exhaust gas flow of a fuel cell of an aircraft comprising a fuel cell for the energy supply of the aircraft, comprising an expansion unit in which the fuel cell exhaust gas is expanded and comprising a condenser for the condensation of water in the fuel cell exhaust gas, with the condenser being flowed through by the fuel cell exhaust gas on its hot side and by a cooling medium on its cold side. Provision is accordingly made for the hot side of the condenser to be connected upstream of the expansion unit and for the dehumidified fuel cell exhaust gas expanded in the expansion unit to serve as the cooling medium. The invention furthermore relates to an aircraft comprising a system in accordance with the invention for water reclamation from an exhaust gas flow of a fuel cell of an aircraft.

The present invention relates to a system for water reclamation from an exhaust gas flow of a fuel cell of an aircraft comprising a fuel cell for the energy supply of the aircraft, comprising an expansion unit in which the fuel cell exhaust gas is expanded and comprising a condenser for the condensation of water from the fuel cell exhaust gas, with the condenser being flowed through by the fuel cell exhaust gas on its hot side and by a cooling medium on its cold side.

A system of this type for water reclamation is known from DE 102 16 709 A1. This printed document relates to a method of water treatment and of the distribution of onboard-generated water in aircraft. A high-temperature fuel cell, which is connected upstream of a condensation process by means of which water is condensed from the exhaust gas of the fuel cell, serves the generation of electrical energy. The condensation process comprises a turbine and a heat exchanger connected downstream of it. The heat exchanger is flowed through by air on its cold side, said air subsequently being supplied to the fuel cell.

A water separation system connected downstream of a fuel cell is furthermore known from DE 198 21 952 C2. It is known from this printed document to guide the exhaust gas flow of the fuel cell over a water condenser cooled by ambient aircraft air, with water being condensed by a lowering of temperature of the humid air and being supplied to a water reservoir by means of a condensate drain.

The air humidification/air conditioning and the WC flushing, the drinking water supply, the supply of water for showers and the supply of water for washing are described as the purpose of use for the separated water in DE 102 16 709 A1.

Previously known systems for water reclamation from an exhaust gas flow of a fuel cell for aircraft applications are characterized by a condenser which is arranged downstream of an expansion turbine in the low-pressure zone and which, as a heat sink, is flowed through, for example, by RAM air.

It is the object of the present invention to further develop a system for water reclamation from an exhaust gas flow of a fuel cell of an aircraft such that its efficiency is increased with respect to already known systems.

This object is satisfied by a system for water reclamation from an exhaust gas flow of a fuel cell of an aircraft having the features of claim 1. Provision is accordingly made for the hot side of the condenser to be connected upstream of the expansion unit and for the dehumidified fuel cell exhaust gas expanded in the expansion unit to serve as the cooling medium. The condensation of the water accordingly takes place in the high-pressure zone. The condensation of the water contained in the exhaust gas flow of the fuel cell is more efficient in the high-pressure zone upstream of the expansion unit due to physical laws so that a higher degree of condensation is obtained and also a more efficient dehydration of the fuel cell exhaust gas can take place than with previously known systems. This makes possible a subsequent cooling of the air to temperatures far below freezing point.

The cooling medium of the condenser is formed by dehumidified fuel cell exhaust gas expanded in the expansion unit.

In a preferred aspect of the invention, the outlet side of the condenser on its hot side is in communication with the inlet side of a water separator. Inflowing air from the condenser is set into rotation in the water separator, for example by installed deflection plates (swirl vanes). The relatively large water drops are slung outwardly by the centrifugal force, where they are collected in a sump. Any other desired aspects of the water separator are generally also conceivable.

It is particularly advantageous for a regenerative heat exchanger to be provided whose hot side is connected upstream of the hot side of the condenser. In this connection, provision is preferably made for the inlet side of the regenerative heat exchanger on its cold side to be in communication with the outlet of the water separator and for its outlet side to be in communication with the inlet of the expansion unit. The regenerative heat transfer in this aspect of the invention has the object of evaporating the remaining residual humidity by supplying heat and of protecting the expansion unit following the regenerative heat transfer device from water hammer and icing and of contributing to the increase in performance of the expansion unit. It is equally conceivable for no reheater to be provided for the fuel cell exhaust gas to be guided into the hot side of the condenser, then into the water separator and from there into the expansion unit. The exhaust gas being discharged from the expansion unit preferably serves as the cooling medium for the condenser or is supplied to the cold condenser side.

Provision can thus be made for the inlet side of the condenser on is cold side to be in communication with the outlet of the expansion unit.

Provision is thus preferably made for the water from the fuel cell exhaust gas to be separated in a high-pressure water separator circuit, with the exhaust gas preferably first flowing through the reheater, then the condenser and finally the water separator in which the water condensed in the condenser is separated. In this aspect of the invention, after passing through the water separator, the dehumidified fuel cell exhaust gas flows through the cold side of the regenerative heat exchanger, with it being heated, and then into the expansion unit which is preferably made as a turbine. The outlet side of the expansion unit is in communication with the inlet side of the cold side of the condenser. The dehumidified fuel cell exhaust gas cooled in the expansion unit preferably serves as a cooling medium for the condenser and is thus utilized for the condensation of the humidity of the fuel cell exhaust gas. After passing through the cold side of the condenser, the fuel cell exhaust gas is discharged to the environment as “off gas”.

Provision can furthermore be made for a main heat transfer device to be provided which is flowed through by fuel cell exhaust gas on its hot side, is connected upstream of the expansion unit and is flowed through by RAM air or cabin air on its cold side. The arrangement of a heat transfer device of this type upstream of the expansion stage has energetic advantages with respect to heat transfer performance and construction size due to the higher temperature difference between the heat sink (RAM air or cabin air) and the heat source (process air or fuel cell exhaust gas).

The main heat transfer device can be arranged in a RAM air passage of an aircraft air-conditioning system or in a separate RAM air passage of an aircraft. Provision is preferably made in ground operation for an electrically driven fan arranged at the outlet of the main heat transfer device to transport external air through the main heat transfer device. This fan is not required if the main heat transfer device is arranged in an existing RAM air passage of an aircraft air-conditioning system (environmental control system (ECS)) and is also supplied with cooling air from there in ground operation. An arrangement of the main heat transfer device in a RAM air passage of an aircraft air-conditioning system anyway present makes the installation of a separate RAM air passage at the aircraft superfluous.

Provision is made in a further aspect of the invention for the water separator to be in communication with the cold side of the main heat transfer device, preferably with its cold inlet side or with the cold side of a RAM air heat transfer device of an aircraft air-conditioning system, preferably with its cold inlet side, so that excess separated water can be injected at the intake of the cooling air of the main heat transfer device or of a RAM air cooler of the ECS or into the main heat transfer device or RAM air cooler in order to increase the cooling performance there.

As stated above, the expansion stage is preferably made as a turbine.

Provision can furthermore be made for the turbine and a compressor to be arranged on a common shaft, the compressor being in communication on the inlet side with the air supply for the fuel cell and on the outlet side with the fuel cell. Provision can furthermore be made for the turbine to be seated on a shaft which is in communication with a motor and/or a generator or which has a motor and/or a transmission. The said compressor can furthermore be arranged on this shaft.

It is equally generally possible to configure the compressor independently of the turbine or expansion unit.

To further increase the energy efficiency of the system, provision can be made for the fuel cell to be supplied from cabin air in flight. This vitiated air represents a substantial exergy potential since it is available at a higher pressure or temperature level than the ambient air. At the end of the process, mechanical power is regained from the remaining pressure energy via the expansion stage or the turbine and is converted to electrical energy via the generator located on the same shaft.

In a further aspect of the invention, a further expansion unit is provided which is acted on by vitiated cabin air on the inlet side and is in communication with the cold side of the main heat transfer device on the outlet side. It is conceivable that some of the cabin air is supplied to the main heat transfer device either directly or via the expansion stage or expansion turbine as a heat sink. If sufficient vitiated cabin air is available, an additional supply of RAM air can be dispensed with. The energetic losses by the utilization of RAM air at the aircraft are hereby reduced. In a defect case (with a loss of cabin pressure), the system is supplied completely via external air and is cooled using RAM air.

Provision is made in a further aspect of the invention for the fuel cell to be a high-temperature fuel cell.

In accordance with the present invention, the term “fuel cell” includes not only an individual fuel cell, but preferably also a fuel cell system, for example a fuel cell stack.

A reformer for the generation of hydrogen can be connected upstream of the fuel cell and an afterburner downstream of it. The reformer can, for example, be an autothermal reformer.

It is particularly advantageous when the fuel cell, the reformer and the afterburner are preferably arranged in a common pressure vessel. The pressure vessel can be pressurized with inert gas, preferably with nitrogen, or also with compressed air, preferably with compressed air compressed in the compressor in accordance with claim 10. An onboard inert gas generation system (OBIGGS) can be provided from which the pressure vessel is supplied with inert gas, preferably with nitrogen.

Provision is made in a further aspect of the invention for no condenser to be connected downstream of the expansion unit. Provision is preferably made for the water to be condensed and separated completely or at least largely before the expansion unit. It is particularly advantageous for the condenser connected upstream of the expansion unit on the hot side to be the only condenser of the system.

As stated above, a particularly high efficiency results when the fuel cell exhaust gas flowing through the condenser on its hot side has a pressure level above the ambient pressure. A high-pressure water separation preferably takes place.

The dehumidified fuel cell exhaust gas which is expanded in the expansion unit and which flows through the condenser on its cold side preferably has a pressure level above or at ambient pressure.

The invention furthermore relates to an aircraft comprising a system for water reclamation from an exhaust gas flow of a fuel cell in accordance with any one of claims 1 to 22. Provision can be made in this connection for the fuel cell to replace an auxiliary gas turbine (auxiliary power unit (APU)) which is typically installed in the tail of aircraft and for the electrical power supply to be realized at an efficient level on the ground and also in flight.

Further details and advantages of the invention will be explained in more detail with reference to an embodiment shown in the drawing. There are shown:

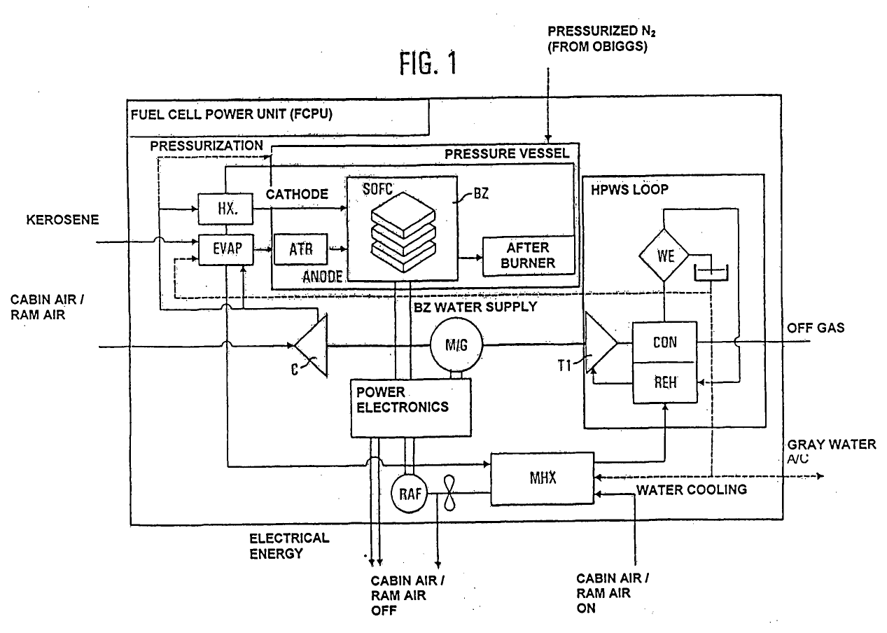

FIG. 1: a schematic representation of the system in accordance with the invention for water reclamation from an exhaust gas flow of a fuel cell of an aircraft;

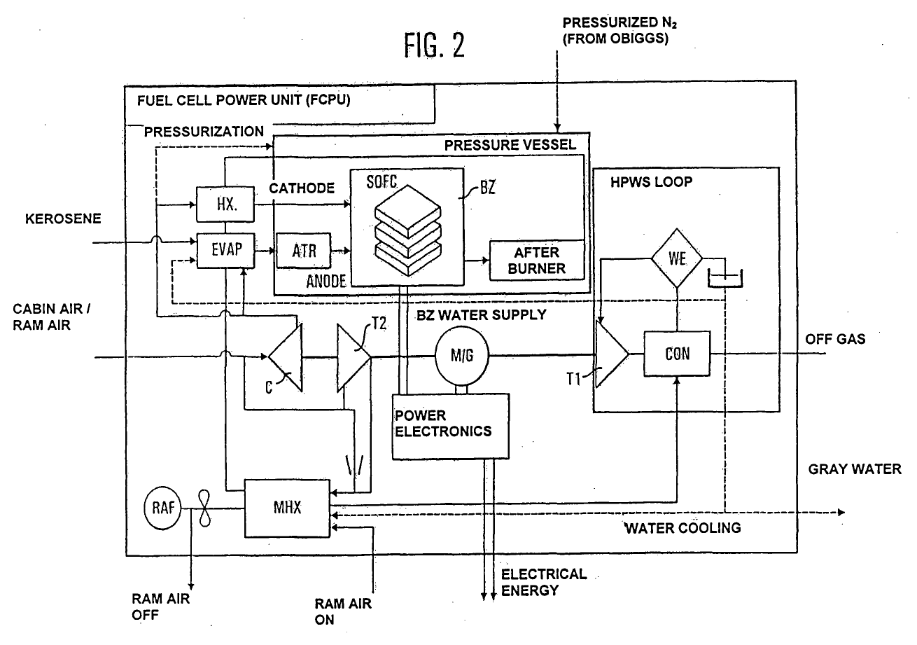

FIG. 2: a system in accordance with FIG. 1 with an additional expansion stage for the cooling of the cabin air and with a modified high-pressure water separation circuit.

FIG. 1 shows the fuel fell BZ or the fuel cell system that serves for the energy supply of an aircraft arranged in a pressure vessel (Press. Vessel). The fuel cell BZ is a high-temperature fuel cell (solid oxide fuel cell (SOFC) which has an autothermal reformer ATR connected upstream of it.

It must be pointed out at this point that the system in accordance with the invention can be operated with any desired type of fuel cell(s). The SOFC is only an exemplary embodiment.

The kerosene supplied, which was evaporated in an evaporator EVAP, is converted to hydrogen and further reaction products in the autothermal reformer ATR. The hydrogen is supplied to the fuel cell BZ at the anode side. The fuel cell BZ is acted on by air (vitiated cabin air or ambient air) at the cathode side, the air being heated in a heat exchanger HX. before the supply to the fuel cell BZ. An afterburner (burner) is connected downstream of the fuel cell and is in communication at the outlet side with the hot side of the said heat exchanger HX. and of the evaporator EVAP, as can be seen from FIG. 1.

As can furthermore be seen from FIG. 1, the fuel cell BZ, the reformer ATR and the afterburner are located in the insulated pressure vessel. The insulated vessel is necessary to ensure the high constant ambient temperature (600 to 800° C.) necessary for the electrochemical process. A further advantage results from the fact that the mechanical pressure strain on the fuel cell or on the fuel cell stack is reduced due to the differential pressure with respect to the vessel environment. The pressure vessel is pressurized by inert gas, preferably by nitrogen to eliminate the risk of explosion when hydrogen is discharged from the reformer ATR or from the fuel cell BZ. As can be seen from FIG. 1, the inert gas can be generated by a system belonging to the aircraft (onboard inert gas generation system (OBIGGS)) which also generates inert gas for the tank ventilation required for safety reasons. The pressure vessel can optionally also be supplied with compressed air which is made available from the compressor C. This option is presented in FIG. 1 with the remark “pressurization”. Due to the component pressure losses after the compressor C, the vessel pressure is always slightly higher than the process pressure, provided the vessel is tight. This has the effect that in the case of a leak at the system components (fuel cell, reformer) air is always pressed into the system and thus no safety-critical concentration can occur in the vessel.

As can furthermore be seen from FIG. 1, the hot fuel cell exhaust gas flows through the main heat transfer device MHX after passing through the evaporator EVAP. This heat transfer device is flowed through on its cold side by ambient air or vitiated cabin air and, in this process, cools the fuel cell exhaust gas supplied on the hot side. An electrically driven fan (RAM air fan (RAF)), which is arranged at the outlet of the main heat transfer device MHX, pulls external air over the main heat transfer device MHX. If the main heat transfer device is arranged in an existing RAM air passage of an aircraft air-conditioning system (ECS) and if this is also supplied with cooling air from there in ground operation, the RAF is not necessary. With a design of this type, the installation of a separate RAM air passage at the aircraft is omitted. It is generally likewise possible for the main heat transfer device to be arranged in a separate RAM air passage, i.e. not in the RAM air passage of an aircraft air-conditioning system.

After flowing through the main heat transfer device MHX, the pre-cooled fuel cell exhaust gas flows into the hot side of a regenerative transfer device REH (termed a reheater in the following) arranged in the high-pressure zone, i.e. upstream of the expansion unit. The fuel cell exhaust gas then flows through the hot side of the condenser CON which is connected downstream of the reheater REH and in which the condensation of water contained in the fuel cell exhaust gas takes place. In the water separator WE connected downstream of the hot side of the condenser, the air flowing in from the condenser CON is set into rotation by installed deflection plates (swirl vanes). The relatively large water drops are slung outwardly by the centrifugal force, where they are collected in the sump shown in FIG. 1. The water separation thus also takes place, like the condensation, in the high-pressure zone, i.e. before the expansion. The fuel cell exhaust gas dehumidified in this manner subsequently flows through the cold side of the reheater REH, with the remaining residual humidity being evaporated by heat supply, which results in the performance increase of the turbine T1 connected downstream of the cold side of the reheater REH and protects it against water hammer and icing. After expansion of the fuel cell exhaust gas in the turbine T1, it is guided through the cold side of the condenser CON and thus serves as the cooling medium for the condensation process. The exhaust gas is subsequently discharged to the ambient aircraft air as off gas.

The water separated off in the water separator is used for the supply of the fuel cell with water (FC water supply), on the one hand. Excess, separated water can optionally preferably be injected at the intake of the cooling air of the main heat transfer device MHX or also of a RAM air cooler of an aircraft air-conditioning system to increase the cooling power there. The supply of the water to the main heat transfer device MHX is indicated by the broken line in FIG. 1.

As can be seen from FIG. 1, the turbine T1 is seated on a common shaft with the compressor C, the motor M and the generator G. The compressor C serves the compression of vitiated cabin air or ambient air which is supplied to the fuel cell system BZ after its compression. As can be seen from FIG. 1, the compressed air is supplied to the evaporator EVAP for kerosene, on the one hand, and to a heat transfer device HX, on the other hand. After flowing through this heat transfer device, the air is delivered to the cathode side of the fuel cell BZ.

To further increase the energy efficiency, it is advantageous for the fuel cell system BZ to be supplied with vitiated cabin air in flight. This vitiated air represents a substantial exergy potential since it is available at a higher pressure or temperature level than the ambient air. It is therefore particularly preferred for the system to be acted on by vitiated cabin air at the inlet side.

The fuel cell BZ in accordance with FIG. 1 serves the provision of electrical energy, which serves, for example, the drive of the motor of the shaft device on which the turbine T1, the compressor C and the generator G are furthermore located. The electrical energy can furthermore be used to drive the fan RAF of the main heat transfer device. Provision can generally be made for the fuel cell BZ to replace an auxiliary gas turbine APU which is typically installed in the tail of an aircraft and realizes the electrical energy supply on ground and during flight at a more efficient level. All influence parameters such as the total energetic efficiency, weight, utilization of RAM air, engine bleed air consumption, etc., which cause an energetic influencing of the aircraft must be taken into account here. Water is condensed from the fuel cell exhaust gas flow by the system in accordance with the invention, preferably to cover the fuel cell system's own water requirements and to use the remaining water on board the aircraft effectively. The aircraft energy requirement necessary to transport the water provision is hereby reduced.

FIG. 2 shows a system for water reclamation from an exhaust gas flow of a fuel cell of an aircraft which differs from the system in accordance with FIG. 1 in that a further turbine T2 is provided. The additional turbine stage T2 expands vitiated cabin air to ambient pressure. The air cooled in this manner is supplied as a heat sink to the main heat transfer device MHX. In the embodiment in accordance with FIG. 2, some of the vitiated cabin air is supplied either directly to the heat transfer device MHX or via the expansion turbine T2 as a heat sink. The main heat transfer device MHX can additionally be flowed through by ambient air on the cold air side. The vitiated cabin air is thus used in accordance with FIG. 2 for the supply of the fuel cell BZ after compression in the compressor C and also for the cooling of the main transfer device MHX. If sufficient vitiated cabin air is available, an additional supply of RAM air can be dispensed with. The energetic losses by the utilization of RAM air at the aircraft are hereby reduced. For the case that a loss of cabin pressure results, the system is supplied with air completely via external air and is cooled with RAM air.

A further difference in the architecture in accordance with FIG. 2 with respect to the system in accordance with FIG. 1 results from the fact that the high-pressure water separation circuit does not have any reheater. As can be seen from FIG. 2, the fuel cell exhaust gas cooled in the main heat transfer device MHX flows directly into the hot side of the condenser CON and from there into the water separator WE for the separation of the condensate. The water separator WE is connected at the outlet side to the inlet side of the expansion stage, i.e. of the turbine T1. The expansion of the dehumidified fuel cell exhaust gas takes place in the turbine T1. After flowing through the turbine T1, the fuel cell exhaust gas is guided as a cooling medium through the cold side of the condenser CON and then discarded. The systems in accordance with FIG. 1 and FIG. 2 correspond to the extent that the fuel cell exhaust gas is dehumidified in a high-pressure water separation circuit (HPWS loop) which is connected upstream of the turbine T1.

As can be seen from FIG. 2, the additional turbine stage T2 is located on a joint shaft with the air compressor C, the exhaust gas turbine T1 and the motor M/generator G.

1. A system for water reclamation from an exhaust gas flow of a fuel cell of an aircraft comprising a fuel cell (BZ) for the energy supply of the aircraft, comprising an expansion unit (T1) in which the fuel cell exhaust gas is expanded and comprising a condenser (CON) for the condensation of water from the fuel cell exhaust gas, with the condenser (CON) being flowed through on its hot side by fuel cell exhaust gas and on its cold side by a cooling medium, characterized in that the hot side of the condenser (CON) is connected upstream of the expansion unit (T1); and in that the cooling medium is formed by dehumidified fuel cell exhaust gas expanded in the expansion unit (T1).

2. A system in accordance with claim 1, wherein the outlet side of the condenser (CON) is in communication at its hot side with the inlet side of a water separator (WE).

3. A system in accordance with claim 1, wherein a regenerative heat exchanger (REH) is provided whose hot side is connected upstream of the hot side of the condenser (CON).

4. A system in accordance with claim 3, wherein the inlet side of the regenerative heat exchanger (REH) on its cold side is communication with the outlet of the water separator (WE) and its outlet side is in communication with the inlet of the expansion unit (T1).

5. A system in accordance with claim 1, wherein the inlet side of the condenser (CON) is in communication at its cold side with the outlet of the expansion unit (T1).

6. A system in accordance with claim 1, wherein a main heat transfer device (MHX) is provided which is flowed through by fuel cell exhaust gas on its hot side, is connected upstream of the expansion unit (T1) and is flowed through by RAM air or cabin air on its cold side.

7. A system in accordance with claim 6, wherein the main heat transfer device (MHX) is arranged in a RAM air passage of an aircraft air-conditioning system or in a separate RAM air passage of an aircraft.

8. A system in accordance with claim 6, wherein the water separator (WE) is in communication with the cold side, preferably with the cold inlet side of the main heat transfer device (MHX) or with the cold side, preferably with the cold inlet side of a RAM air heat transfer device of an aircraft air-conditioning system so that excess, separated water can be injected at the intake of the cooling air of the main heat transfer device (MHX) or in the main heat transfer device or at the intake of the cooling air of a RAM air heat transfer device or in the RAM air heat transfer device of an aircraft air-conditioning system.

9. A system in accordance with claim 1, wherein the expansion unit (T1) is designed as a turbine.

10. A system in accordance with claim 9, wherein the turbine is seated on a shaft with a compressor (C) which is in communication on the inlet side with the air supply for the fuel cell (BZ) and on the outlet side with the fuel cell (BZ).

11. A system in accordance with claim 9, wherein the turbine is seated on a shaft on which a motor (M) and/or a generator (G) is/are located or which is in communication with a motor (M) and/or a generator (G).

12. A system in accordance with claim 6, wherein a further expansion unit (T2) is provided which is acted on by vitiated cabin air on the inlet side and is in communication with the cold side of the main heat transfer device (MHX) on the outlet side.

13. A system in accordance with claim 1, wherein the fuel cell (BZ) is a high-temperature fuel cell.

14. A system in accordance with claim 1, wherein a reformer (ATR) for the manufacture of hydrogen is connected upstream of the fuel cell (BZ) and an afterburner (burner) is connected downstream of it.

15. A system in accordance with claim 14, wherein the fuel cell (BZ), the reformer (ATR) and the afterburner (burner) are arranged in a common pressure vessel.

16. A system in accordance with claim 15, wherein the pressure vessel is pressurized with inert gas, preferably with nitrogen.

17. A system in accordance with claim 16, wherein an onboard inert gas generation system (OBIGGS) for the generation of the inert gas, preferably of the nitrogen, is provided which is in communication with the pressure vessel.

18. A system in accordance with claim 15, wherein the pressure vessel is pressurized by compressed air, preferably compressed air compressed in a compressor (C) which is in communication on the inlet side with the air supply for the fuel cell (BZ) and on the outlet side with the fuel cell (BZ), said compressor being seated on a shaft with the expansion unit (T1), the expansion unit (T1) being designed as a turbine.

19. A system in accordance with claim 1, wherein no condenser is connected downstream of the expansion unit (T1).

20. A system in accordance with claim 1, wherein the condenser connected upstream of the expansion unit (T1) on the hot side is the only condenser of the system.

21. A system in accordance with claim 1, wherein the fuel cell exhaust gas flowing through the condenser (CON) on its hot side has a pressure level above the ambient pressure.

22. A system in accordance with claim 1, wherein the dehumidified exhaust gas expanded in the expansion unit (T1) has a pressure level over or at the ambient pressure.

23. An aircraft comprising a system for water reclamation from an exhaust gas flow of a fuel cell in accordance with claim 1.
